(19) United States
(12) Patent Application Publication
(10) Pub. No.: US 2007/0145293 A1
(43) Pub. Date: Jun. 28, 2007

(54) Secure tag validation

(75) Inventor: Joseph D. Roth, Springboro, OH (US)

Correspondence Address: Christopher P. Ricci;Intellectual Property Section, Law Department, NCR Corporation, 1700 South Patterson Blvd., Dayton, OH, 45479-0001, US

(73) Assignee: NCR Corporation

(21) Appl. No.: 11/318,956

(22) Filed: Dec. 27, 2005

(51) Int. Cl. G01J 1/58

(52) U.S. Cl. 250/458.1; 250/461.1

(57) ABSTRACT

A programmable device for validating a secure tag. The device comprises: an excitation source; a controller coupled to the excitation source; a detector coupled to the controller; and a communications port coupled to the controller. The controller receives updated time period information via the communications port. During operation, the controller activates and de-activates the excitation source, which illuminates the secure tag. The controller also causes the detector to measure luminescence from the tag in accordance with time period information set by the controller. This enables the time period information to be changed to reduce the possibility of a counterfeit secure tag replicating the luminescence from a genuine secure tag.

The present invention relates to improvements in or relating to secure tag validation.

### BACKGROUND

Secure tags are used for a number of different purposes; a primary purpose being prevention of counterfeiting.

One type of secure tag that has recently been developed is based on small particles of a rare earth doped host, such as glass. This type of secure tag is described in US patent application No. 2004/0262547, entitled “Security Labelling,” and US patent application No. 2005/0143249, entitled “Security Labels which are Difficult to Counterfeit”, both of which are incorporated herein by reference.

These rare earth doped particles (hereinafter “RE particles”) can be applied to valuable items in different ways. For example, the secure tags can be incorporated in fluids which are applied (by printing, spraying, painting, or such like) to valuable items, or incorporated directly into a substrate (paper, rag, plastic, or such like) of the valuable items.

In response to suitable excitation, RE particles produce a luminescence spectrum having narrow peaks because of the atomic (rather than molecular) transitions involved. Known readers for RE particles include (i) a suitable excitation source to stimulate transitions in the secure tag, and (ii) a detector to measure the luminescence emitted in response to the excitation.

Luminescence is a generic term that includes both fluorescence and phosphorescence.

Fluorescent materials (dyes and pigments) have a decay lifetime of 10⁻⁹ to 10⁻⁷ seconds (1 to 100 nanoseconds). The fluorescence disappears very quickly after excitation ceases. Thus, detecting fluorescence is typically performed simultaneously with excitation.

Phosphorescent materials (dyes and pigments) have a decay lifetime of 10⁻³ to 100 seconds. Thus the phosphorescence persists for a relatively long time period after excitation ceases. Detecting phosphorescence can be done simultaneously with excitation. However, it is also possible to measure the phosphorescence after the excitation is removed. Measuring the phosphorescence after the excitation is removed adds to the security of a phosphorescent tag.

RE particles typically luminescence relatively weakly compared with some substrates on which they are mounted (for example, paper). However, RE particles have the advantage of a relatively long luminescence decay time (that is, RE particles are phosphorescent pigments); typically the luminescence decay time is much longer than fluorescence from paper. This enables a delay to be used between exciting the RE particles and measuring the luminescence emitted in response to the excitation. This decay time provides an intrinsic security feature for secure tags based on RE particles.

Secure tags are only useful to the extent that they are difficult to counterfeit, so it is desirable to provide more secure ways of validating secure tags, particularly tags based on RE particles. It is particularly desirable to have a secure way of validating secure tags that can be updated to counteract any counterfeit tags that are discovered after the secure tags have been issued.

### SUMMARY

According to a first aspect of the invention there is provided a programmable device for validating a secure tag, the device comprising: an excitation source which can illuminate the secure tag; a controller coupled to the excitation source, and which activates and de-activates the excitation source; a detector coupled to the controller, the detector being operable, in response to the controller, to measure luminescence from the tag in accordance with time period information set by the controller; and a communications port coupled to the controller by which the controller receives updated time period information, whereby time period information can be changed to reduce the possibility of a counterfeit secure tag replicating the luminescence from a genuine secure tag.

By virtue of this aspect of the invention, a device can be updated in the field by sending new time period information. The new time period information is selected to ensure that counterfeit secure tags do not have the same luminescence as genuine secure tags. This ensures that security can be restored by updating the device without having to update the secure tags themselves. This is particularly advantageous in embodiments where secure tags are used in items that will be in use for a relatively long period of time, such as polymer banknotes.

By virtue of this aspect of the invention, a counterfeit secure tag has to be able to replicate the exact decay characteristics of the genuine secure tag to ensure that the counterfeit tag will be validated. This greatly increases the difficulty in counterfeiting the secure tag.

The time period information may have two components. The first component is a detection window during which luminescence is measured, that is, the time period during which the detector is integrating luminescence measurements. The second component is time delay period, which is the delay between exciting the secure tag and the start of the detection window. Thus, time period information can refer to both when a measurement is taken, and how long the measurement lasts. Alternatively, the time period information may be either the detection window or the time delay period.

The controller may also receive updated acceptance criterion information corresponding to the updated time period information, because the acceptance criterion changes as the time delay period changes, and may also change as the detection window changes. The acceptance criterion information may be in the form of an algorithm or data.

Multiple excitation sources may be used. In such devices, a first source may be activated to excite the secure tag, luminescence is then measured after one or more time delays set by the controller. A second source (emitting at a different wavelength to the first source) may then be activated, and luminescence measured after one or more time delays set by the controller. Using multiple excitation sources makes it more difficult to counterfeit the secure tag, because the luminescence decay rate must be replicated by the counterfeit tag at multiple excitation frequencies.

According to a second aspect of the invention there is provided a method of validating secure tags, the method comprising: illuminating a secure tag; ceasing illumination of the secure tag; waiting for a dynamically updatable time delay to elapse from ceasing illumination of the secure tag; measuring luminescence from the secure tag after the dynamically updatable time delay has elapsed; validating the secure tag in the event the measured luminescence matches an acceptance criterion.

The acceptance criterion may be fulfilled by matching (i) a signature derived from the luminescence measured from the secure tag, with (ii) one of a plurality of predetermined luminescence signatures.

The method of validating secure tags may further comprise: receiving updated time delay information; and updating the dynamically updatable time delay based on the received time delay information.

A signature may be derived from the presence or absence of emission at one or more wavelengths; the presence or absence of a peak in emission at one or more wavelengths; the number of emission peaks within all or a portion of the electromagnetic spectrum comprising, for example, ultraviolet radiation to infrared radiation (e.g., approximately 10 nm to 1 mm, but a typical usable range may be 180 nm to 3000 nm); the rate of change of emission versus wavelength, and additional derivatives thereof; rate of change of emission versus time, and additional derivatives thereof; absolute or relative intensity of emission at one or more wavelengths; the ratio of an intensity of one emission peak to an intensity of another emission peak or other emission peaks; the shape of an emission peak; the width of an emission peak; or such like.

Measuring the luminescence at various decay times of an individual luminescent component adds another parameter to a security feature that a counterfeiter must replicate to duplicate the security feature. This adds to the security of the tag.

Furthermore, the time period over which the detector measures luminescence (the detection window) can also be varied, which increases security.

Additional security may be added by including two or more different luminescent materials, each having a different luminescence decay rate. This has the effect that the contribution from each of the luminescent materials to the luminescence spectrum depends on the delay between excitation and detection. Changing the delay will result in a different luminescence spectrum. Thus, to simulate this security feature, a counterfeiter must know what delay will be used. Additional security can be added by measuring spectra at multiple (different) delays.

A luminescent tag having a plurality of luminescent materials, each with a different decay rate, can be used to provide increased levels (or layers) of security. For example, luminescence may be measured after a first delay, and then after a second delay, and the tag only validated if the luminescence spectra measured after both delays match the anticipated luminescence spectra.

According to a third aspect of the invention there is provided a method of improving the security of an item incorporating one or more of a first type of secure tags at a first location, the method comprising: ascertaining a decay rate of the first type of secure tags; identifying a second type of secure tag having a different decay rate to the first type; incorporating the second type of secure tag into the item at the first location; determining a luminescence signature at a predetermined time period resulting from the combination of the first and second types of secure tags; and using the determined signature to validate the item.

The first type of secure tag is preferably a matrix (such as borosilicate glass) doped with a rare earth ion (such as Dysprosium), and the second type of secure tag is preferably also a matrix (such as borosilicate glass) doped with another rare earth ion (such as Europium) or a combination of rare earth ions.

The first type of secure tags may have a first (long) decay. For example, the first decay may be approximately fifteen milliseconds (15 ms), and a relatively long delay (approximately eight milliseconds (8 ms)) may be used between de-activating an excitation source and activating a detector. As used herein, the decay time refers to the time taken for the luminescence to decay to background intensity levels.

If it is suspected that the first type of secure tags has been compromised, then the second type of secure tags may be incorporated into the carrier at the same general location as the first type of secure tags.

The second type of secure tags may have a second (shorter) decay time. For example, the second decay may be approximately 7 milliseconds (7 ms)), and a relatively short delay (approximately two milliseconds (2 ms)) may be used between de-activating the excitation source and activating the detector.

The luminescence spectrum measured after the short delay (2 ms in this example) is a combination of the luminescence from the first type of secure tags and the second type of secure tags. The luminescence spectrum after the long delay (8 ms in this example) is from the first type of secure tags only, because the luminescence from the second type of secure tags has decayed to background levels.

Readers (such as validation devices) for the secure tags can be provided (or updated) to measure spectra after the short delay and also after the long delay. In this way the expected spectra at the short delay depends on the date of manufacture of the document (or other item the secure tags are incorporated into). This is a second level of security. The first level of security is unaffected because readers that are not updated to measure a luminescence spectrum after the second (shorter) delay will not identify a valid document as counterfeit.

According to a fourth aspect of the invention there is provided a secure time delay updating system comprising a server and a plurality of programmable devices for validating a secure tag, the server being operable to issue updated time period information to the plurality of programmable devices.

According to a fifth aspect of the invention there is provided a programmable device for validating a secure tag, the device comprising: an excitation source which can illuminate the secure tag; a controller coupled to the excitation source, and which activates and de-activates the excitation source; a detector coupled to the controller, the detector being operable, in response to the controller, to measure luminescence from the tag in accordance with time delay information provided by the controller.

These and other aspects of the present invention will be apparent from the following specific description, given by way of example, with reference to the accompanying drawings.

### BRIEF DESCRIPTION OF THE DRAWINGS

In the accompanying drawings:

FIG. 1 is a schematic diagram of a secure tag reader according to one embodiment of the present invention;

FIG. 2 is a table illustrating the luminescence decay time for luminescence peaks from two different types of rare earth ions (Europium and Dysprosium);

FIG. 3 is a schematic diagram of a banknote incorporating a secure tag for validating by the reader of FIG. 1;

FIG. 4 is a block diagram of a secure validation system including the reader of FIG. 1; and

FIG. 5 is a schematic diagram of another banknote incorporating two types of secure tag for validating by the reader of FIG. 1.

### DETAILED DESCRIPTION

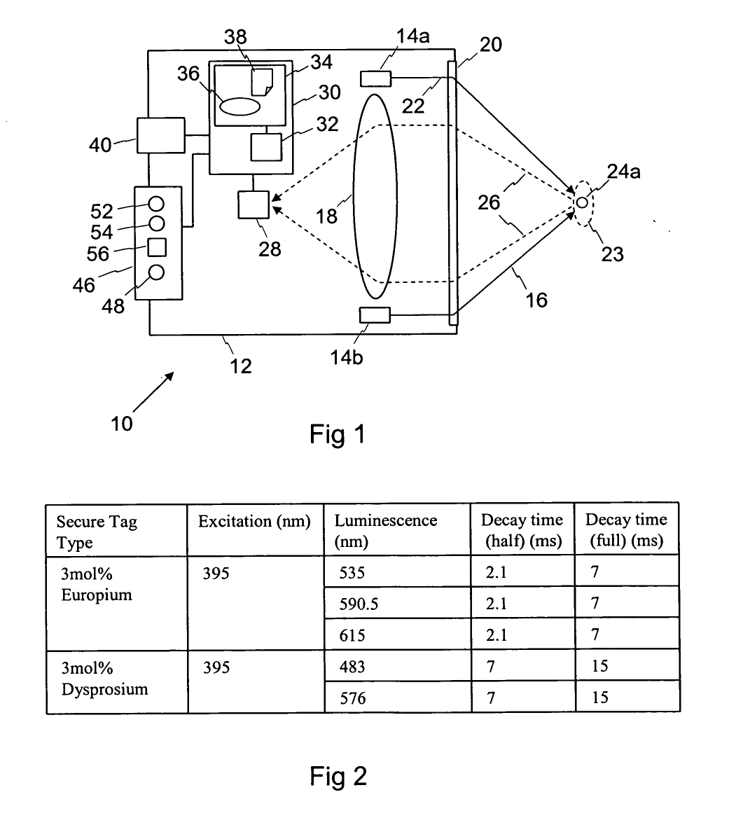

Reference is first made to FIG. 1, which is a schematic diagram of a secure tag reader 10 according to one embodiment of the present invention.

The reader 10 is a hand-held unit and comprises a housing 12 in which an excitation source 14 is mounted. The excitation source 14 is in the form of a pair of LEDs circumferentially spaced around a collecting lens 18. The LEDs emit at approximately 395 nm, which is visible to the human eye and corresponds to the deep blue region of the electromagnetic spectrum.

A Fresnel lens 20 is mounted at a window in the housing 12 to focus radiation (illustrated by arrows 22) from the excitation source 14 onto a focus spot (illustrated by broken line 23) at which a group of secure tags 24a will be located.

Luminescence emitted from the secure tags 24a (illustrated by broken arrows 26) is directed by the Fresnel lens 20 onto the collecting lens 18, which in turn focuses the luminescence onto a detector 28, which is an imaging sensor in the form of a CMOS sensor.

The CMOS sensor 28 is coupled to a controller 30.

The controller 30 comprises: a processor 32 and non-volatile memory (NVRAM) 34.

The processor 32 receives intensity data from the CMOS sensor 28 and processes this data to identify luminescence peaks, as will be described in more detail below.

The NVRAM 34 stores a processing algorithm 36 that is used by the processor 32, and also a file 38 containing time period information. The time period information file includes time delay information and detection window information.

The controller 30 controls activation of the excitation source 14 and also activation of the CMOS sensor 28, so that the sensor 28 detects luminescence when activated by the controller 30. The controller 30 uses the time period information file 38 to determine when to activate the CMOS sensor 28 (using the time delay information), and for how long to activate the CMOS sensor 28 (using the detection window information).

The processor 32 uses the processing algorithm 36 to create a photoluminescence signature (PL signature) from luminescence detected by the CMOS sensor 28 and compare this with pre-stored PL signatures.

The controller 30 is coupled to a USB port 40 for outputting data, or the results of analysis on the data, and for receiving updated time delay information from a remote source (as will be described in more detail with reference to FIG. 4).

The reader 10 also includes a simple user interface 46 coupled to the controller 30. The user interface 46 comprises: a trigger 48, which allows a user to activate the reader 10; a red LED 52, which indicates a failure to authenticate a secure tag; a green LED 54, which indicates a successfully authenticated secure tag; and a loudspeaker 56, which emits a short beep when a secure tag is successfully authenticated, and a long beep when a secure tag is not successfully authenticated.

The decay of luminescence intensity over time varies between different rare earth ions. FIG. 2 is a table illustrating the decay times for a secure tag consisting of borosilicate glass doped with 3 mol % of Europium; and the decay times for a secure tag consisting of borosilicate glass doped with 3 mol % of Dysprosium. For each rare earth ion, the table shows the decay time for the instantaneous luminescence signal to reach half of the initial luminescence signal; and also the decay time for the instantaneous luminescence signal to decay to the background luminescence reading. It will be immediately evident that the decay time for Dysprosium tags is more than double that for Europium tags. This feature is relied on in this embodiment.

In this embodiment, the reader 10 is intended to read secure tags 24a comprising 3 mol % of Dysprosium in borosilicate doped glass. The principles of manufacturing Dysprosium-doped borosilicate glass are described in US patent application No. 2005/0143249, entitled “Security Labels which are Difficult to Counterfeit”.

In this embodiment, time period information file 38 includes a time delay parameter of seven and a half milliseconds (7.5 ms), thereby ensuring that most luminescence from other sources has decayed prior to luminescence measurements being recorded by the reader 10; and a detection window parameter of one millisecond (1 ms).

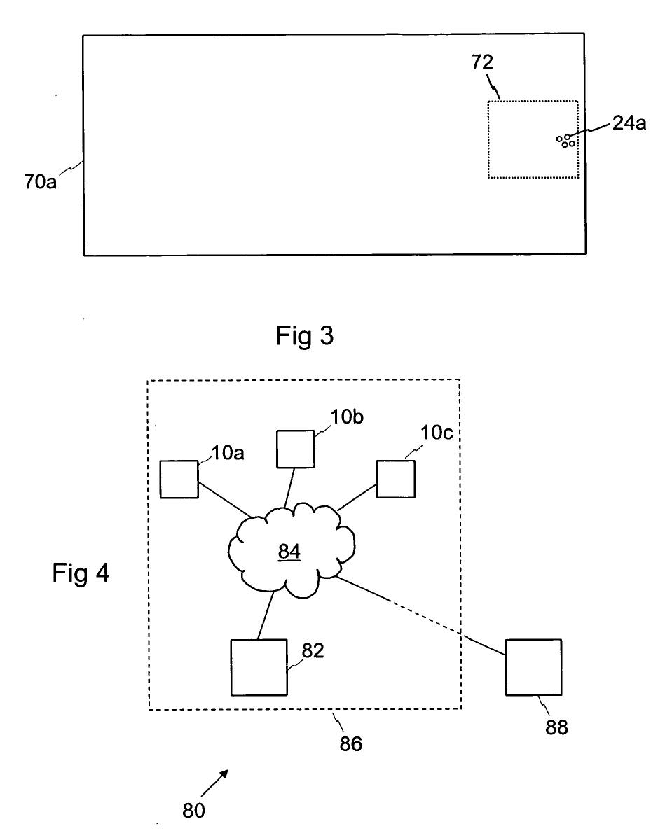

Reference is now made to FIG. 3, which illustrates a valuable media item 70a, in the form of a banknote, which is printed with ink incorporating secure tags 24a at a tag area 72 on the banknote 70a. The tags 24a comprise small beads (typically having an average diameter of five microns or less) of 3 mol % of Dysprosium-doped borosilicate glass. For clarity, in FIG. 3 the tags 24a are greatly enlarged with respect to the banknote 70a, and only a few tags 24a are shown.

When the banknote 70a is to be validated, the reader's focus spot 23 and the tag area 72 are aligned. This alignment is achieved either by moving the banknote 70a or by moving the reader 10, or both. This alignment may be performed manually, or by the controller 30 if a motorized transport is used.

Once the reader 10 and banknote 70a are aligned, the user presses the trigger 48.

On receipt of a trigger press, the controller 30 activates the LEDs 14 which illuminate the secure tags 24a for a pre-determined length of time, in this embodiment five milliseconds (5 ms). The controller 30 then de-activates the LEDs 14 and waits for the time delay specified by the time delay information file 38 to elapse. In this embodiment, the time delay is set to seven and a half milliseconds (7.5 ms).

Once the time delay has elapsed, the controller 30 activates the CMOS sensor 28 for a period of time corresponding to the detection window (1 ms), which records luminescence from the secure tags 24a and any background radiation.

The controller 30 then determines (using the processing algorithm 36) if an acceptance criterion has been fulfilled. In this embodiment, this involves two tests. The first test involves measuring the luminescence intensities at 483 nm and 576 nm; ascertaining the ratio of these luminescence intensities; and comparing the ascertained ratio with a pre-determined luminescence intensity ratio (a luminescence signature) to determine if the ascertained ratio matches the pre-determined ratio. The second test involves ensuring that only background levels of luminescence are measured at 535 nm and 615 nm to ensure that a broadband response is not being measured.

If the acceptance criterion is met, then the controller 30 activates the green LED 54 and causes the loudspeaker 56 to emit a short beep.

If the acceptance criterion is not met, then the controller 30 activates the red LED 52 and causes the loudspeaker 56 to emit a long beep.

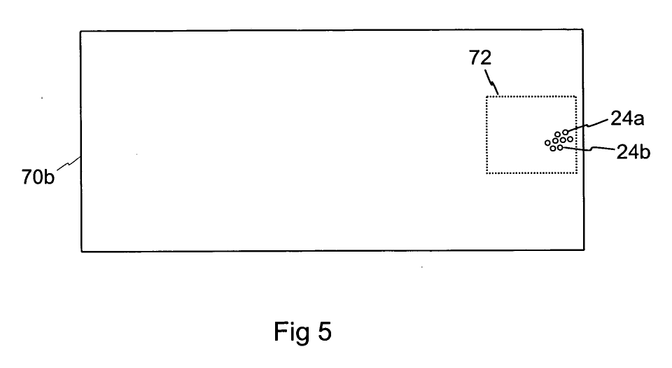

If it is suspected that the secure tag 24a has been compromised, that is, that counterfeit tags are now in circulation, then the reader 10 is updated in an effort to foil the new counterfeit tags. This will now be described with reference to FIG. 4, which is a block diagram of a secure validation system 80 including the reader 10. Reference will also be made to FIG. 5, which is a schematic diagram of a new banknote including the secure tags 24a and new secure tags.

When it is suspected that the secure tag 24a has been counterfeited, then new banknotes 70b can be issued that include the secure tags 24a and new secure tags 24b in the tag area 72. The new tags 24a are selected based on certain desired properties.

In this embodiment, new tags 24b are selected that have a decay time much shorter than that of 3 mol % Dysprosium. The tags 24b selected comprise 3 mol % Europium-doped borosilicate glass. As can be seen from FIG. 2, the full decay time for luminescence from 3 mol % Europium tags 24b is seven milliseconds (7 ms), which is substantially less than that of 3 mol % Dysprosium. This means that luminescence can be measured before 7 ms elapses, which will contain contributions from both Dysprosium tags 24a and Europium tags 24b, and after 7 ms elapses, which will contain contributions from only Dysprosium tags 24a not Europium tags 24b.

Referring now to FIG. 4, the secure validation system 80 includes three readers (labeled 10a,b,c), each substantially the same as reader 10 connected to a local server 82 by a network 84 (in this embodiment the Internet). In this embodiment, the readers 10 and server 82 are located within a retail store 86. The system 80 also includes a remote server 88 that serves multiple stores 86 and other locations via the Internet 84.

The remote server 88 stores the latest time period information files and corresponding updated acceptance criterion information (in the form of algorithms 36 or data for algorithms 36). The remote server 88 manages controlled deployment of this information. The remote server 88 may charge a fee for supplying the latest updates to retailers, banks, and such like.

The remote server 88 transfers the latest time period information and acceptance criterion files to the local server 82 for controlled deployment throughout the store 86. The remote server 88 and the local servers 82 communicate via secure protocols.

Once the local server 82 receives an updated file, the server 82 conveys this file to each reader 10 in the store via the USB port 40 (which may include a wireless network card, such as an 802.11-g card).

On receipt of an updated file, the controller 30 within each reader 10 updates the time period information file 38 in NVRAM 34 and also the algorithm 36 (with the received acceptance criterion information).

Once the controller 30 has updated the reader 10, when a banknote 70 is presented to the reader 10, and the trigger is pressed, the controller 30 activates the LEDs 14 which illuminate the secure tags 24a and 24b for a pre-determined length of time, in this embodiment 5 milliseconds (5 ms). The controller 30 then de-activates the LEDs 14 and waits for the time delays specified by the updated time delay information file 38 to elapse. In this embodiment, the first time delay is set to four milliseconds (4 ms).

Once this first time delay (4 ms) has elapsed, the controller 30 activates the CMOS sensor 28, which records luminescence from the secure tags 24a and any background radiation for 1 ms (the detection window).

The controller 30 then waits for the second time delay specified by the updated time delay information file 38 to elapse. In this embodiment, the second time delay is set to seven and a half milliseconds (7.5 ms), which is the same as the previous time delay when only one time delay was used.

Once the second time delay has elapsed, the controller 30 again activates the CMOS sensor 28, which records luminescence from the secure tags 24a (luminescence from secure tags 24b having decayed to background levels) and any background radiation for 1 ms (the detection window).

The controller 30 then uses the processing algorithm 36 to determine if an acceptance criterion has been fulfilled. In this embodiment, this involves two tests conducted after each time delay has elapsed. The first test involves measuring the luminescence intensities at 483 nm and 576 nm; ascertaining the ratio of these luminescence intensities; and comparing the ascertained ratio with a pre-determined luminescence intensity ratio (a luminescence signature) to determine if the ascertained ratio matches the pre-determined ratio. The second test involves measuring the luminescence intensities at 535 nm and 615 nm; ascertaining the ratio of these luminescence intensities; and comparing the ascertained ratio with a pre-determined luminescence intensity ratio to determine if the ascertained ratio matches the pre-determined ratio.

For the shorter time delay (4 ms), there will be strong luminescence measured at 535 nm and 615 nm because these wavelengths correspond to luminescence peaks arising from the 3 mol % Europium tags 24b, as shown in FIG. 2.

For the longer time delay (7.5 ms), there will be no (or only background levels of) luminescence measured at 535 nm and 615 nm because the luminescence from the 3 mol % Europium tags 24b will have decayed to background levels.

If the acceptance criterion is met, then the controller 30 activates the green LED 54 and causes the loudspeaker 56 to emit a short beep.

If the acceptance criterion is partially met (that is, if the test at the longer time delay is satisfied but the test at the shorter time delay is not satisfied), then both the green LED 54 is pulsed, which indicates a partially successful authentication. An operator of the reader 10 can then determine if the banknote 70 is old, and therefore does not contain the new tags 24b, or if the banknote 70 is new and is a counterfeit.

If the acceptance criterion is not met, then the controller 30 activates the red LED 52 and causes the loudspeaker 56 to emit a long beep.

It should now be appreciated that this embodiment has the advantage that a reader can be updated to detect new media items that are genuine, while still validating older media items that are genuine.

Various modifications may be made to the above described embodiments within the scope of the present invention. For example, in other embodiments, different security tags 24 may be used than those described, for example, non-RE particles, or RE particles containing different RE ions, or a different host. In other embodiments, different illumination sources and/or detectors may be used, depending on the luminescence to be stimulated and detected. In other embodiments, the wavelengths used for excitation, and the wavelengths detected may be different, depending on the type of secure tag, the dopant ion or ions, the concentration of the dopant, and such like.

In other embodiments, the reader may be free-standing, desk-mounted or incorporated into another terminal (such as an ATM, a point of sale terminal, a teller assist terminal, a banknote validator, a kiosk, or such like).

In other embodiments, the detector that records luminescence from the secure tags 24a may operate continuously, but only store luminescence values in response to a signal from the controller.

In other embodiments different electronic architectures may be used than that described with reference to FIG. 4. For example, a peer to peer transfer of time delay information may be provided. In other embodiments a secure, private network may be used.

In other embodiments, the processing algorithm 36 may be updated when a new acceptance criterion is to be applied by the controller 30. In other embodiments, the time delay information and the processing algorithm may be provided as a single file.

In other embodiments, the reader 10 may implement multiple cycles of excitation, delay, reading, and concatenate the results to reduce the effects of noise, background radiation, and such like.

In one embodiment, the acceptance criterion may comprise matching a pre-stored signature with a signature derived from the secure tag. A signature may be derived from a secure tag by normalizing luminescence from rare earth doped particles (RE particles). In such an embodiment, the RE particles are illuminated (excited) and the resulting luminescence spectrum is measured, which comprises an intensity at each of multiple wavelengths. To normalize the measured luminescence spectrum, the intensity at a predetermined wavelength in the spectrum may be used as a reference by which the intensity at all other wavelengths in the spectrum will be scaled. In other words, the measured intensity of those wavelengths of interest in the luminescence spectrum, which may be all of the wavelengths measured, or a sub-set thereof, will be scaled relative to the measured intensity at the predetermined wavelength.

Subsequently, the scaled emission intensity at each wavelength of interest is translated into a data block comprising a predetermined number of bits. As an example, if there are eight wavelengths of interest, then eight data blocks are produced, each having a predetermined number of bits.

Translation of the scaled intensities may use digitization error correction, such as parity bits, to take account of boundary problems. This ensures that a given intensity will consistently translate to the same data block value even if the intensity varies by a relatively small amount (such as five percent) when measured at different times, and/or under different conditions, and such like. The individual data blocks are then concatenated to produce a continuous sequence of data blocks for further use. This continuous sequence of data blocks can, for example, be used by itself as a signature for the illuminated RE particles, or it can be used to form part of a more complex signature for the RE particles.

Representing a signature as a sequence of bits allows a generated signature to be matched with one or more pre-stored signatures very quickly and easily using digital comparing techniques, for example, an exclusive nor (XNOR) Boolean function. Once matched, the signature can be validated.

In the above embodiments, the controller 30 determines (using the processing algorithm 36) if an acceptance criterion has been fulfilled; whereas, in other embodiments, a remote processor may perform this task. This allows a high power processor to be shared by multiple secure tag readers, thereby reducing the cost of each secure tag reader.

In the above embodiments, the detection window was the same for both time delays; whereas, in other embodiments, each time delay may have a different detection window.

What is claimed is:

1. A reader for validating a secure tag, the reader comprising: an excitation source which can illuminate the secure tag; a controller coupled to the excitation source, and which activates and de-activates the excitation source; a detector coupled to the controller, the detector being operable, in response to the controller, to measure luminescence from the tag in accordance with time period information provided by the controller.

2. A reader according to claim 1, wherein the time period information comprises: time delay information indicating when luminescence is to be measured, and a detection window indicating for how long luminescence is to be measured.

3. A programmable device for validating a secure tag, the device comprising: an excitation source which can illuminate the secure tag; a controller coupled to the excitation source, and which activates and de-activates the excitation source; a detector coupled to the controller, the detector being operable, in response to the controller, to measure luminescence from the tag in accordance with time period information set by the controller; and a communications port coupled to the controller by which the controller receives updated time period information, whereby time period information can be changed to reduce the possibility of a counterfeit secure tag replicating the luminescence from a genuine secure tag.

4. A programmable device according to claim 3, wherein the device comprises multiple excitation sources.

5. A programmable device according to claim 3, wherein the controller stores a plurality of predetermined luminescence signatures for comparing with a signature derived from the luminescence measured from the tag.

6. A programmable device according to claim 5, wherein the controller stores an algorithm implementing an acceptance criterion.

7. A programmable device according to claim 6, wherein the acceptance criterion is fulfilled when the signature derived from the luminescence measured from the tag matches one of the plurality of predetermined luminescence signatures.

8. A method of validating secure tags, the method comprising:
illuminating a secure tag;
ceasing illumination of the secure tag;
waiting for a dynamically updatable time delay to elapse from ceasing illumination of the secure tag;
measuring luminescence from the secure tag after the dynamically updatable time delay has elapsed;
validating the secure tag in the event the measured luminescence matches an acceptance criterion.

9. A method according to claim 8, wherein the acceptance criterion is fulfilled by matching a signature derived from the luminescence measured from the secure tag with one of a plurality of predetermined luminescence signatures.

10. A method according to claim 8, wherein the method further comprises:
receiving updated time delay information; and
updating the dynamically updatable time delay based on the received time delay information to change the time at which luminescence is measured form the secure tag and thereby reduce the possibility of a counterfeit secure tag replicating the luminescence from a genuine secure tag.

11. A method of improving the security of an item incorporating one or more of a first type of secure tags at a first location, the method comprising:
identifying a second type of secure tag having a different decay rate to the first type;
incorporating the second type of secure tag into the item at the first location;
ascertaining a luminescence signature at a predetermined time period resulting from the combination of the first and second types of secure tags; and
using the ascertained luminescence signature to validate the item.

12. A method according to claim 11, wherein the first type of secure tag is a matrix doped with a rare earth ion, and the second type of secure tag is also a matrix doped with another rare earth ion.
